(19) United States
(12) Patent Application Publication
(10) Pub. No.: US 2024/0091757 A1
(43) Pub. Date: Mar. 21, 2024

(54) ACTIVATION OF REDUCED AND PASSIVATED CATALYST

(71) Applicant: JOHNSON MATTHEY PUBLIC LIMITED COMPANY, London (GB)

(72) Inventors: Alan BOOTLAND, Billingham, Cleveland (GB); David DAVIS, Billingham, Cleveland (GB); Mikael CARLSSON, Billingham, Cleveland (GB); Jonathon HIGGINS, Billingham, Cleveland (GB); Andrew Edward RICHARDSON, Billingham, Cleveland (GB); John WEST, Billingham, Cleveland (GB); Emma SOFTLEY, Billingham, Cleveland (GB)

(21) Appl. No.: 18/263,661

(22) PCT Filed: Mar. 3, 2022
(86) PCT No.: PCT/GB2022/050559

§ 371 Date: Jul. 31, 2023

(30) Foreign Application Priority Data
Mar. 17, 2021 (GB) 2103658.7

(51) Int. Cl. B01J 37/08; B01J 23/755; B01J 33/00; B01J 37/14; B01J 37/18; C01B 3/40

(52) U.S. Cl. CPC B01J 37/08; B01J 23/755; B01J 33/00; B01J 37/14; B01J 37/18; C01B 3/40; C01B 2203/0233; C01B 2203/1058

(57) ABSTRACT

A method for activating a catalyst is described comprising the steps of: (i) installing a reduced and passivated catalyst containing crystallites of a catalytic metal comprising nickel, cobalt or iron in elemental form encapsulated by a layer comprising an oxide of the catalytic metal in a reactor, such as a steam methane reforming reactor, in which it is to be used, and (ii) heating the reduced and passivated catalyst in the reactor under a vacuum or an inert gas to a temperature in the range (T_{T}−X) to (T_{T}+Y), where T_{T} is the Tammann temperature of the catalytic metal in elemental form in degrees Centigrade, X is 400 and Y is 200, to form a catalytically active surface on the catalyst without requiring the application of a reducing gas.

This invention relates to methods of activating catalysts, in particular the in-situ activation of reduced and passivated catalysts.

Metal catalysts that in the active form contain metal in elemental form, for example nickel-, cobalt- or copper-containing catalysts, can be difficult to handle because of their propensity to self-heat on exposure to air. In consequence, such catalysts are often supplied in oxidic form and activated in-situ by reduction of the metal oxide to elemental form with a reducing gas, typically containing hydrogen, prior to use. The reduction process can be lengthy and requires a ready source of the reducing gas and apparatus to remove the by-product water. Certain catalysts may be provided in a reduced and passivated condition in which the catalyst contains crystallites of the catalytic metal in elemental form encapsulated by an oxide layer. Such catalysts are still reduced using a reductant, such as hydrogen or a synthesis gas containing hydrogen, and have the advantage that the time for reduction and the quantity of reducing gas is lower, but apparatus for the separation of the by-product water is still necessary.

We have found an alternative, simpler, method that avoids the problems of the prior art activation methods.

Accordingly the invention provides a method a method for activating a catalyst comprising the steps of: (i) installing a reduced and passivated catalyst containing crystallites of a catalytic metal comprising nickel, cobalt or iron in elemental form encapsulated by a layer comprising an oxide of the catalytic metal in a reactor in which it is to be used, and (ii) heating the reduced and passivated catalyst in the reactor under a vacuum or an inert gas to a temperature in the range (T_{T}−X) to (T_{T}−FY), where T_{T} is the Tammann temperature of the catalytic metal in elemental form in degrees Centigrade, X is 400 and Y is 200, to form a catalytically active surface on the catalyst.

The Tammann temperature is a known attribute of metals and is the temperature at which the atoms or molecules of the solid acquire sufficient energy for their bulk mobility and reactivity to become appreciable. The Tammann temperature is typically one-half of the melting point, for example the Tammann temperature for cobalt is 604° C. and for nickel is 590° C.

Without wishing to be bound by theory, the inventors believe that by heating the reduced and passivated catalyst, the material restructures to provide a portion of catalytically active metal in elemental form at the surface of metal crystallites, to create a catalytically active surface on the catalyst without requiring the application of a reducing gas or other reductant.

The activation method may be applied to reduced and passivated catalysts containing nickel, cobalt or iron. The catalytically active metals may be present in the reduced and passivated catalyst in an amount in the range of 1 to 95% by weight (expressed as the metal). The method may be particularly applied to catalysts containing catalytically active metals selected from cobalt, iron and nickel, which are normally reduced using a reducing gas. The applicants have found that nickel-containing catalysts are particularly suitable for activation by the present method. Reduced and passivated nickel catalysts activated by the present method may have a nickel content of the in the range 1 to 95% by weight, preferably 10 to 60% by weight, more preferably 30 to 60% by weight.

The reduced and passivated catalyst contains crystallites of a metal in elemental form encapsulated by a layer comprising an oxide of the metal. The crystallites are dispersed over the surface of a support that physically separates the metal crystallites providing the catalyst with a high metal surface area. The crystallites may be formed by precipitation of reducible metal compounds and support compounds from solution or impregnation of reducible metal compounds on a support. The reduced metal surface area of the catalysts in the present invention may be in the range 5 to 50 m²/g of catalyst.

By “reduced and passivated” we mean that the catalyst contains a metal reducible to elemental form, that has been subjected to a prior reduction step to form catalytic metal in elemental form ex-situ, i.e. not in the reactor in which it is to be used, and that the catalytic metal in elemental form has been passivated by encapsulating it in a layer comprising the oxide of the metal by a suitable oxidising treatment. The layer comprising metal oxide may consist of metal oxide or may include metal carbonate. The layer comprising metal oxide provides a barrier against bulk oxidation of the catalyst so that it may be safely handled in air without self-heating. The ex-situ reduction step may be performed using any known method by applying a reducing agent or reducing gas to an oxidic material under conditions to convert at least a portion of the metal oxide into elemental form. For example, by heating the metal oxide of the catalytically active metal in the catalyst to temperatures in the range 175 to 600° C. in a flow of a reducing gas containing hydrogen. The reducing gas may be pure hydrogen or a diluted hydrogen stream, such as a mixture of hydrogen and nitrogen or a synthesis gas comprising hydrogen and carbon monoxide. The passivation may be performed using any known method by applying an oxidising agent to the reduced catalyst to re-oxidise a surface layer on the elemental metal and thereby encapsulate the metal in elemental form with a layer comprising metal oxide. For example, passivation may be performed using oxygen, air and/or carbon dioxide, suitably diluted with an inert gas such as nitrogen or argon, under controlled conditions. Such methods are known. For example, methods of making reduced and passivated cobalt and nickel catalysts are disclosed in US2013184360 (A1) and GB2118453 (A) respectively.

The reduced and passivated catalyst desirably possesses only sufficient passivation of the elemental catalytic metal to prevent the unwanted self-heating during normal handling and transportation. Too little passivation and the catalyst may be unstable; too much and the heating step may be overly lengthy. Therefore, a preferred degree of oxidation, which may be expressed as degree of reduction (DoR) of the passivated catalyst, is in the range 10 to 90%. For nickel catalysts the DoR may be 10-90% but is preferably in the range 20 to 80%, more preferably in the range 35-70%. For cobalt catalysts the DoR may be 10-90% but is preferably in the range 20 to 80%, more preferably in the range 35-65%. The DoR may readily be established by known temperature-programmed reduction (TPR) methods. A suitable method comprises flowing hydrogen through a sample, initially at ambient temperature. While the gas is flowing, the temperature of the sample is increased linearly with time and the consumption of hydrogen is monitored. The Degree of Reduction (DoR) can then be calculated as a percentage by:

$$D o R = \frac{a}{b} * 100$$

where a is the amount of reducible metal that has been reduced (moles/g) and b is the total amount of reducible metal present in the material (moles/g). Amount of reducible metal that has been reduced can be calculated using the principal oxide phase. For nickel monoxide the ratio for dihydrogen consumption is 1:1, therefore,

a=b−c
where c is the total dihydrogen consumption.

The activation method includes installation of the reduced and passivated catalyst in a reactor in which it is to be used. In some embodiments, where the reduced and passivated catalyst contains nickel or cobalt, the reactor may be a methanation reactor, a hydrogenation reactor, a Fischer-Tropsch reactor or a steam reforming reactor. Cobalt catalysts may be used in hydrogenation reactors and Fischer-Tropsch reactors. Where reduced and passivated catalyst contains nickel, the reactor may be a methanation reactor, a hydrogenation reactor, or a steam reforming reactor. One or more process streams fed to the reactor and over the catalyst may be gaseous or liquid. The present invention is of particular utility for nickel-containing catalysts in steam reforming reactors where the temperature of the reduced and passivated catalyst may be readily adjusted to provide the active surface on the catalyst. The steam reforming reactor may be any type of steam reforming reactor.

The activation method includes a step of heating the reduced and passivated catalyst. Unlike previous activation methods, the heating step (ii) is performed in the absence of a reducing agent. The heating step may be performed by externally-heating the reactor or catalyst container within the reactor that contains the reduced and passivated catalyst to the desired temperature. The heating step heats the reduced and passivated catalyst to a temperature in the range (T_{T}−X) to (T_{T}−FY), where T_{T} is the Tammann temperature of the catalytic metal in elemental form in degrees Centigrade, X is 400 and Y is 200, to form a catalytically active surface on the catalyst. Without wishing to be bound by theory, the Applicant believes that by heating the reduced and passivated catalyst as claimed the material restructures to provide a portion of catalytically active metal in elemental form at the surface of metal crystallites and thereby form a catalytically active surface. The Tammann temperature is generally one half of the melting point of the catalytic metal and may be established from known references, such as Heterogeneous Catalyst Deactivation and Regeneration: A Review by M. D. Argyle and C. Bartholomew in Catalysts March 2015, 5(1), p145-269. The lower temperature to which the catalyst may be heated is given by T_{T}−X degrees Centigrade, where X is 400. Thus, X may be in the range of 1 to 400. For example, X may be 350, 250, 200, 100 or 50, or less. The upper temperature to which the catalyst may be heated is given by T_{T}+Y degrees Centigrade, where Y is 200. Thus, Y may be in the range of 1 to 200. For example, Y may be 150, 125, 100, 75, 50, 25 or less. Above the Tammann temperature, sintering of the metal crystallites can occur causing the metal surface area to drop and so reduce the catalytic activity. Accordingly, it is preferred that Y is 100 or less.

Where the catalyst is a nickel catalyst, the temperature in step (ii) to which the reduced and passivated catalyst is heated may be in the range 190 to 790° C., preferably 300 to 700° C., more preferably, most preferably 400 to 600° C. The temperature may also usefully be in the ranges 190 to 700° C., more preferably, most preferably 190 to 600° C.

The reduced and passivated catalyst may be heated at a constant or varying ramp rate, and may be heated in one, two or more stages and held at one or more intermediate temperatures, or at the maximum temperature, for a period, which may be termed “dwell period”. The heating step may be performed over 1 to 24 hours but is preferably in the range 1 to 16 hours, including any dwell periods.

In order that the catalytically active surface formed by heating is not deactivated by oxidation, the heating step should be performed under vacuum or under an inert gas. The vacuum is preferably at least 98.70% 1 bar or 100.01 kPa negative gauge). The inert gas may be any gas that does not react with the catalytically active metal, and is suitably selected from nitrogen, helium and argon. Small amounts of other gases, such oxygen, may be present in the inert gas. The oxygen (02) content of the inert gas should be minimised and is preferably 0.010% more preferably 0.002% by volume.

The invention further provides an activated catalyst obtained by heating a reduced and passivated catalyst according to the method as described above.

After the heating step, the catalyst may be brought on-line, after adjustment to the desired operating temperature, by passing reactant gases to the catalyst in the reactor.

Accordingly, the invention may include a step of passing a reactant gas mixture over the catalytically active surface to form a product mixture.

The invention is now further described by reference to the following Examples.

### EXAMPLE 1: REDUCED AND PASSIVATED CATALYST PREPARATION

Catalyst A was KATALCO® CRG-F, a precipitated nickel catalyst, commercially available from Johnson Matthey PLC. The catalyst contained 61.3% nickel, expressed as Ni. The catalyst may be prepared by co-precipitation as described in U.S. Pat. No. 4,250,060.

The catalyst was supplied in oxidic form and so was first reduced and passivated as follows: 1 g of the catalyst was charged into a quartz reactor in an Altamira AMI200 Dynamic Chemisorption device. The catalyst was first dried under 50 cc/min argon by raising the temperature to 35° C. and then increasing the temperature at 10° C./min to 100° C. before holding at 100° C. for 60 minutes. The catalyst was then reduced in 100% vol hydrogen flowing over the sample at 50 cc/min. During the reduction step the temperature was increased at 10° C./min up to 650° C. where it was held for 2 hours. The reduced catalyst was then cooled under a 50 cc/min flow of a 50:50 mixture of helium and argon at a rate of 30° C./min to a final temperature of 25° C. where it was held for 30 minutes. The reduced catalyst was then passivated by flowing a mixture of 48 cc/min helium and 2 cc/min oxygen over the reduced catalyst for 60 minutes, held at 25° C. The passivated catalyst was then treated with a mixture of 10 cc/min oxygen and 40 cc/min helium at 25° C. for 60 minutes before discharge from the reactor. The properties of the reduced and passivated catalyst are set out in Table 1:

TABLE 1
Catalyst A properties

| | | | Degree of |
|---|---|---|---|
| | Ni content (% wt | Maximum Reduction | Reduction |
| Catalyst | expressed as Ni) | Temperature (° C.) | (DoR, %) |
| A | 61.3 | 460 | 65 |

The Ni content was established using X-Ray Fluorescence (XRF). The DoR was measured as follows: 0.1 g of the reduced and passivated catalyst was weighed and charged into a quartz reactor in the Altamira AMI200 Dynamic Chemisorption device. The catalyst was subjected to a drying process whereby it was heated under a flow of 40 ml/min argon to 140° C. at 10° C./min and held for 1 hour. The catalyst was then cooled to room temperature (ca 20° C.). The catalyst was then treated with a mixture of 10% vol hydrogen in argon at 40 ml/min while increasing the temperature at 10° C./min up to 1000° C. where it was held for 15 minutes. The hydrogen consumption was quantified using a thermal conductivity detector. The amount of hydrogen consumed was then used, in conjunction with elemental analysis from XRF, to calculate the degree of reduction of the sample as the moles of hydrogen consumed equals the moles of nickel oxide reduced to nickel metal, according to the chemical equation:

NiO+H₂→Ni+H₂O

The DoR was then be calculated by the following equation:

$$D o R = \frac{( b - c )}{b} \times 100$$

where c is the moles of hydrogen consumed during the measurement, and b is the moles of nickel, in any form, present in the original sample analysed.

### EXAMPLE 2: ACTIVATION WITHOUT APPLYING A REDUCING GAS

The reduced and passivated catalyst from Example 1 was placed in a reaction vessel and heated either under vacuum or under flowing nitrogen gas for 2 hours and the hydrogen adsorption monitored. Hydrogen adsorption is considered to be a measure of activation as it occurs once the nickel is in elemental form. Approximately 1 g of reduced and passivated Catalyst A material was weighed into a glass reaction vessel and heated under nitrogen flow (200 cc/minute) or vacuum using a ramp rate of 10° C./minute to the desired temperature. The material was held at the temperature for a further 120 minutes. The catalyst was then cooled to 35° C. under vacuum then held for 60 minutes below 10 μmHg (1.333224 Pa). At this point a leak test was conducted. Hydrogen adsorption was then measured at 35° C. over a pressure range 100-760 mmHg (13332.2-101325 Pa), building an adsorption isotherm. The total adsorption at 760 mmHg based on the weight of the oxidic catalysts before reduction and passivation is reported.

Consecutive runs with increasing activation temperature were conducted on single aliquots of sample, following the method above each time.

The Tammann temperature for Ni is 590° C., and so the temperature range within the invention for Ni is 190-790° C.

Hydrogen adsorption was measured at 35° C. At this temperature no reduction of the nickel oxide layer occurs, and so adsorption demonstrates that a catalytically active surface has been formed by the heating step. The results are set out in Tables 2 and 3:

TABLE 2
Heated under nitrogen

| Catalyst | Temperature (° C.) | H₂ adsorption (cm³/g) |
|---|---|---|
| A | 300 | 12.1 |
| | 500 | 12.3 |
| | 700 | 8.9 |

TABLE 3
Heated under vacuum

| Catalyst | Temperature (° C.) | H₂ adsorption (cm³/g) |
|---|---|---|
| A | 120 | 0.1 |
| | 300 | 10.3 |
| | 500 | 10.8 |
| | 700 | 8.5 |

The results demonstrate that a catalytically-active surface has been generated.

### EXAMPLE 3: REDUCED AND PASSIVATED CATALYST PREPARATION

Catalyst B was HIFUEL® P410, a precipitated nickel catalyst, commercially available from Johnson Matthey PLC. The catalyst contained 45.0% nickel, expressed as Ni.

The catalyst may be prepared by co-precipitation of a mixture of nickel, magnesium and aluminium nitrates with sodium carbonate and adding alumina trihydrate or kaolin with optional hydraulic cement as described in GB1504866

The catalyst was supplied in oxidic form and so was first reduced and passivated as described in Example 1. The properties of the reduced and passivated catalyst are set out in Table 4:

TABLE 4
Catalyst B properties

| | | | Degree of |
|---|---|---|---|
| | Ni content (% wt | Maximum Reduction | Reduction |
| Catalyst | expressed as Ni) | Temperature (° C.) | (DoR, %) |
| B | 450 | 540 | 44 |

### EXAMPLE 4: ACTIVATION WITHOUT APPLYING A REDUCING GAS

The reduced and passivated catalyst from Example 3 was placed in a reaction vessel and heated either under vacuum or under flowing nitrogen gas as described in Example 2. The results are set out in Tables 5 and 6:

TABLE 5
Heated under nitrogen

| Catalyst | Temperature (° C.) | H₂ adsorption (cm³/g) |
|---|---|---|
| B | 300 | 5.1 |
| | 500 | 6.3 |
| | 700 | 6.5 |

TABLE 6
Heated under vacuum

| Catalyst | Temperature (° C.) | H₂ adsorption (cm³/g) |
|---|---|---|
| B | 120 | 0.1 |
| | 300 | 5.2 |
| | 500 | 6.5 |
| | 700 | 6.7 |

The results demonstrate that a catalytically-active surface has again been generated.

### EXAMPLE 5: REACTIVITY OF THERMALLY ACTIVATED CATALYST

Test 5A. The reduced and passivated catalyst from Example 3 was activated in a micro-reactor by heating approximately 5 g of catalyst to 600° C. under a flow of 100 Normal litres/hour nitrogen at 20 barg and holding it at this temperature for 125 minutes. Then water, at a rate of 225 ml/hour, was introduced to the reactor and vapourised prior to reaching the catalyst. After 10 minutes, methane was fed in at a rate of 100 Normal litres/hour, and the nitrogen flow was stopped. The pressure remained at 20 barg. These conditions were maintained for 46 hours, at which point the flows of methane and water were stopped, nitrogen was applied, and the system was cooled to ambient temperature. During the test, the exit gas was analysed by infra-red spectroscopy to establish methane conversion.

Test 5B. In comparison, Test 5A was repeated except that the catalyst was tested in oxidic form and not pre-reduced and passivated. The results are set out in Table 7.

TABLE 7
Steam methane reforming activity

% vol methane converted

| Test | 0.5 hrs | 12 hrs |
|---|---|---|
| 5A | 48 | 48 |
| 5B | 0 | 0 |

These tests demonstrate the activation of the reduced and passivated catalyst according to the method produces a catalyst suitable for steam methane reforming.

1. A method for activating a catalyst comprising the steps of: (i) installing a reduced and passivated catalyst containing crystallites of a catalytic metal comprising nickel, cobalt or iron in elemental form encapsulated by a layer comprising an oxide of the catalytic metal in a reactor in which it is to be used, and (ii) heating the reduced and passivated catalyst in the reactor under a vacuum or an inert gas to a temperature in the range (T_{T}−X) to (T_{T}+Y), where T_{T} is the Tammann temperature of the catalytic metal in elemental form in degrees Centigrade, X is 400 and Y is 200, to form a catalytically active surface on the catalyst.

2. The method according to claim 1, wherein the catalytic metal in the reduced and passivated catalyst comprises nickel.

3. The method according to claim 2, wherein the nickel content of the reduced and passivated catalyst is in the range 1 to 95% by weight.

4. The method according to claim 1, wherein, the reduced and passivated catalyst has a degree of reduction in the range of 10 to 90%.

5. The method according claim 1, wherein the activation step (ii) is performed under a vacuum of at least 98.7%.

6. The method according to claim 1, wherein the activation step (ii) is performed under an inert gas selected from nitrogen, helium and argon.

7. The method according to claim 1, wherein the catalytically active metal is nickel and the temperature in step (ii) to which the reduced and passivated catalyst is heated is in the range 190 to 790° C.

8. The method according to claim 1, wherein the reactor is a methanation reactor, a hydrogenation reactor, a Fischer-Tropsch reactor or a steam reforming reactor.

9. The method according claim 2, wherein the reactor is a methanation reactor, a hydrogenation reactor, or a steam reforming reactor.

10. The method according to claim 1, further comprising a step of passing a reactant gas mixture over the catalytically active surface to form a product mixture.

11. An activated catalyst obtained by the method according to claim 1.

12. The method according to claim 2, wherein the nickel content of the reduced and passivated catalyst is in the range 10 to 60% by weight.

13. The method according to claim 1, wherein the activation step (ii) is performed under nitrogen containing less than 0.010% by volume of oxygen.

14. The method according to claim 2, wherein the reactor is a steam reforming reactor.
